(19) United States
(12) Patent Application Publication
(10) Pub. No.: US 2026/0235147 A1
(43) Pub. Date: Aug. 13, 2026

(54) Verification Assembly Method

(71) Applicant: Illinois Tool Works Inc., Glenview, IL (US)

(72) Inventor: Mark A. Beyer, Armada, MI (US)

(21) Appl. No.: 19/465,600

(22) Filed: Jan. 30, 2026

Related U.S. Application Data
(60) Provisional application No. 63/756,882, filed on Feb. 11, 2025.

(51) Int. Cl. F16B 5/06

(52) U.S. Cl. CPC F16B 5/0621; F16B 2200/95

(57) ABSTRACT

A fastener assembly includes an assembly-verification insert configured to indicate proper installation. The assembly-verification insert includes a verification head and spring legs configured to engage a retainer. The verification head supports a blocking tab and a movable plunger carrying an installation indicator. Prior to full installation, the blocking tab obstructs visibility of the installation indicator. When the assembly-verification insert is properly seated, interaction with the retainer moves the plunger to displace the blocking tab and expose the installation indicator, which may be machine-readable to verify correct assembly.

### RELATED APPLICATION

The present application claims priority to United States Provisional Patent Application No. 63/756,882, filed Feb. 11, 2025, and entitled “Verification Assembly Method,” which is hereby incorporated by reference in its entirety.

### BACKGROUND

Automotive components require fastening techniques that are simple to manufacture and assemble. Above all, fastening techniques should be reliable and efficient. In some instances, objects must be secured to a vehicle to mitigate movement and/or shifting during operation, which can result in release of, damage to, or kinking of the object. For example, airbags, tubes, hoses, wires, and other objects are often secured to vehicle components via fasteners. When a fastener is installed incorrectly, such as when the fastener is not fully inserted into an opening, the fastener can detach and/or the object being fastened can become damaged or loose. Similarly, when an object is attached incorrectly to a fastener, the object can detach from the fastener or become damaged or loose.

In manufacturing and assembly processes, particularly in automotive and structural component assembly, it is essential to ensure that each fastener is correctly positioned and securely fastened relative to the components being joined. Incorrect installation can lead to misalignment, structural weaknesses, and potential failures. To address these issues, visual inspection systems and automated inspection systems are often used; however, these systems may not ensure complete accuracy or reliable confirmation of proper installation. Accordingly, there is a need for a fastening system that includes a built-in verification mechanism configured to confirm secure and correct installation.

Therefore, it would be desirable to provide an installation indicator configured to enhance proper installation of a fastener assembly relative to associated components during assembly.

### SUMMARY

The present disclosure relates generally to a fastening system for forming a connection between components. More specifically, the disclosure relates to a fastener having an installation indicator configured to indicate proper installation of a fastener assembly relative to components during assembly, substantially as illustrated and described in connection with one or more figures and as set forth in the claims.

### DRAWINGS

The foregoing and other objects, features, and advantages of the devices, systems, and methods described herein will be apparent from the following description of examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective assembly view of a fastening system including a fastener assembly in accordance with aspects of this disclosure.

FIG. 1b illustrates a perspective view of the fastener assembly of FIG. 1a in a fully assembled position.

FIG. 1c illustrates a second perspective view of the fastener assembly.

FIG. 2a illustrates a perspective front view of the fastener assembly in a disassembled position.

FIG. 2b illustrates a perspective cross-sectional view of the fastener assembly in the disassembled position, taken along cutline A-A of FIG. 1b.

FIG. 2c illustrates a side elevation view of the fastener assembly in the disassembled position.

FIG. 2d illustrates a perspective view of an assembly-verification insert of the fastener assembly in the disassembled position.

FIG. 2e illustrates a top plan view of the assembly-verification insert of the fastener assembly in the disassembled position.

FIG. 3a illustrates a perspective front view of the fastener assembly in a first assembled position (e.g., a shipment position).

FIG. 3b illustrates a perspective cross-sectional view of the fastener assembly in the first assembled position, taken along cutline A-A of FIG. 1b.

FIG. 3c illustrates a side elevation view of the fastener assembly in the first assembled position.

FIG. 3d illustrates a perspective view of the assembly-verification insert of the fastener assembly in the first assembled position.

FIG. 3e illustrates a top plan view of the assembly-verification insert of the fastener assembly in the first assembled position.

FIG. 4a illustrates a perspective front view of the fastener assembly in a second assembled position (e.g., a fully assembled position).

FIG. 4b illustrates a perspective cross-sectional view of the fastener assembly in the second assembled position, taken along cutline A-A of FIG. 1b.

FIG. 4c illustrates a side elevation view of the fastener assembly in the second assembled position.

FIG. 4d illustrates a side elevation cross-sectional view of the fastener assembly in the second assembled position.

FIG. 4e illustrates a perspective view of the assembly-verification insert of the fastener assembly in the second assembled position.

FIG. 4f illustrates a top plan view of the assembly-verification insert of the fastener assembly in the second assembled position.

FIGS. 5a and 5b illustrate, respectively, assembly and assembled isometric views of the fastener assembly with associated components and a verification system.

### DESCRIPTION

References to items in the singular include the plural and vice versa, unless otherwise stated or clear from the context. Conjunctive terms are intended to encompass all disjunctive and conjunctive combinations of associated elements unless otherwise indicated. Recitation of ranges of values is not intended to be limiting and includes all individual values within the range unless otherwise specified. Terms such as “first,” “second,” “top,” “bottom,” “side,” “front,” and “back” are used for convenience and are not intended to be limiting.

The terms “about,” “approximately,” and “substantially,” when accompanying a numerical value, indicate a deviation that would be appreciated by one of ordinary skill in the art while still permitting satisfactory operation for an intended purpose. The use of examples or exemplary language is intended to illustrate embodiments and does not limit the scope of the disclosure. The terms “e.g.” and “for example” denote non-limiting examples.

The term “processor” refers to one or more processing devices implemented in hardware, software, or a combination thereof, including, but not limited to, microprocessors, controllers, digital signal processors, application-specific integrated circuits, field-programmable gate arrays, systems-on-chip, state machines, and combinations thereof. A processor may be coupled to or integrated with a memory device, which may include one or more suitable volatile or non-volatile storage media.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is an assembly verification system, a fastener assembly incorporating assembly verification, and a method for verifying proper assembly. In prior art systems, assembly confirmation requires two distinct components, with a scannable code provided on one component and a blocking feature provided on another. This separation increases both system complexity and manufacturing cost. In contrast, the scannable feature disclosed herein is integrated into a single component, thereby reducing overall complexity and cost.

The disclosed fastener assembly comprises multiple components, including an assembly-verification insert and a retainer. The assembly-verification insert includes a planar surface configured to provide an installation indicator. The installation indicator may comprise a scannable verification feature, such as a QR code or barcode. The verification feature may be applied as a label, laser-engraved after molding, or otherwise formed using any suitable technique.

In certain aspects, the installation indicator is positioned on the surface of a movable plunger. The plunger may be pivotally attached to the insert, for example via a flexible living hinge, such that the installation indicator is selectively exposed upon proper assembly.

In one example, an assembly-verification insert for use with a fastener assembly comprises: a verification head; a pair of spring legs extending from the verification head; at least one blocking tab coupled to the verification head; and at least one movable plunger coupled to the verification head, wherein the at least one movable plunger comprises an installation indicator, and wherein the at least one movable plunger is movable relative to the verification head between a first position in which the blocking tab obstructs the installation indicator and a second position in which the installation indicator is visible.

In some examples, the verification head comprises a fixed body portion and the at least one movable plunger is coupled to the fixed body portion via a hinge.

In some examples, the hinge is a living hinge.

In some examples, the blocking tab is hingedly coupled to the verification head and configured to pivot between an obstructing position and a non-obstructing position.

In some examples, movement of the movable plunger biases the blocking tab from the obstructing position to the non-obstructing position.

In some examples, the installation indicator is positioned on a protruding portion of the movable plunger.

In some examples, the installation indicator comprises a fiducial marker.

In some examples, the fiducial marker comprises a barcode, a quick response (QR) code, an AprilTag, or a combination thereof.

In some examples, each pair of spring legs comprises a lock tab configured to engage a retainer.

In some examples, the lock tab is configured to secure the assembly-verification insert in a first assembled position and a second assembled position relative to the retainer.

In some examples, the assembly-verification insert is formed as a unitary plastic component.

In some examples, the movable plunger is movable between a pre-installation position and an installed position.

In another example, a fastener assembly for coupling a first component relative to a second component comprises: an assembly-verification insert comprising a verification head, a pair of spring legs extending from the verification head, at least one blocking tab supported by the verification head, and at least one movable plunger coupled to the verification head and comprising an installation indicator; and a retainer having a body portion defining a retainer opening and a pair of retainer legs resiliently coupled to the body portion, wherein the retainer opening is configured to receive the pair of spring legs, and wherein engagement between the retainer and the movable plunger causes the movable plunger to move such that the installation indicator becomes visible.

In some examples, each of the pair of spring legs comprises a lock tab.

In some examples, each of the pair of retainer legs defines a first cutout configured to receive the lock tab to secure the assembly-verification insert in a first assembled position.

In some examples, each of the pair of retainer legs further defines a second cutout configured to receive the lock tab to secure the assembly-verification insert in a second assembled position.

In some examples, the first assembled position is a part-in-assembly (PIA) position and the second assembled position is a fully installed position.

In some examples, the verification head comprises a fixed body portion and the at least one movable plunger is coupled to the fixed body portion via a hinge.

In some examples, the movable plunger is configured to pivot relative to the fixed body portion between a recessed position and an installed position.

In some examples, the blocking tab is configured to prevent detection of the installation indicator prior to full installation of the fastener assembly.

In some examples, the retainer comprises a stamped metal component.

In some examples, the assembly-verification insert comprises a molded plastic component.

In some examples, the fastener assembly further comprises a load plate positioned between the fastener assembly and the first component.

In some examples, the load plate defines a plate opening configured to receive the pair of spring legs and the pair of retainer legs.

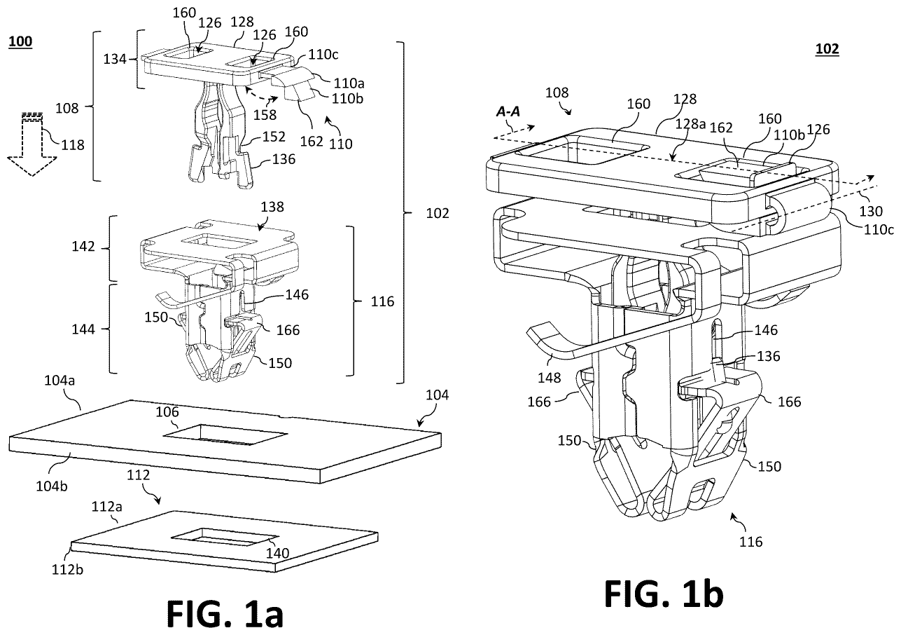

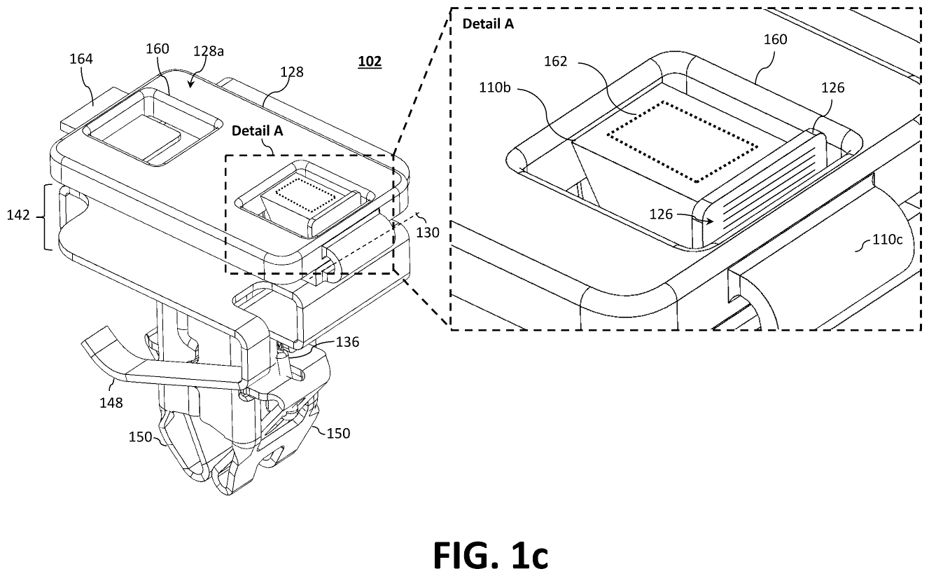

FIGS. 1a through 1c illustrate a fastening system 100 in accordance with aspects of this disclosure that is configured to secure two or more components via a fastener assembly 102. FIG. 1a illustrates a perspective assembly view of the fastening system 100 with a fastener assembly 102 in accordance with aspects of this disclosure. The illustrated fastening system 100 generally comprises a fastener assembly 102 for installation in a first component 104 and a second component 112. FIG. 1b illustrates a perspective view of the fastener assembly 102 of FIG. 1a in a fully assembled position. FIG. 1c illustrates a second perspective view of the fastener assembly 102.

As illustrated, the fastener assembly 102 generally comprises an assembly-verification insert 108 and a retainer 116. The assembly-verification insert 108 and the retainer 116 of the fastener assembly 102 are configured to engage and securely retain one another, thereby facilitating a reliable connection between the first component 104 and the second component 112. This engagement ensures that the first component 104 and the second component 112 remain properly aligned and connected throughout assembly and installation.

The first component 104 defines an A-side surface 104a (e.g., a first surface, such as an exterior surface) and a B-side surface 104b (e.g., a second surface, such as an interior surface). The second component 112 similarly defines an A-side surface 112a (e.g., a first surface, such as an exterior surface) and a B-side surface 112b (e.g., a second surface, such as an interior surface). The first component 104 and/or the second component 112 may be, for example, automotive panels or structural components of a vehicle, such as doors, pillars (e.g., A-pillars, B-pillars, C-pillars, etc.), airbags, dashboard components (e.g., cross members, brackets, frames, etc.), seat frames, center consoles, fenders, sheet metal frameworks, or the like. Depending on the application, the first component 104 and/or the second component 112 may be fabricated from metal (or metal alloys), synthetic or semi-synthetic polymers (e.g., plastics such as acrylonitrile butadiene styrene (ABS) and polyvinyl chloride (PVC)), composite materials (e.g., fiberglass), or combinations thereof.

Each of the first component 104 and the second component 112 includes, defines, or otherwise provides one or more openings (e.g., holes or cutouts) formed during manufacturing of the first component 104 and the second component 112, as applicable. As best illustrated in FIG. 1a, the first component 104 defines a first opening 106 and the second component 112 defines a second opening 140, each configured to receive and retain the fastener assembly 102 relative to the first component 104 and the second component 112.

In the illustrated example, the first component 104 provides the first opening 106 as a rectangular opening sized to receive a portion of the fastener assembly 102, while the second component 112 provides the second opening 140 as a rectangular opening sized to receive a portion of the fastener assembly 102.

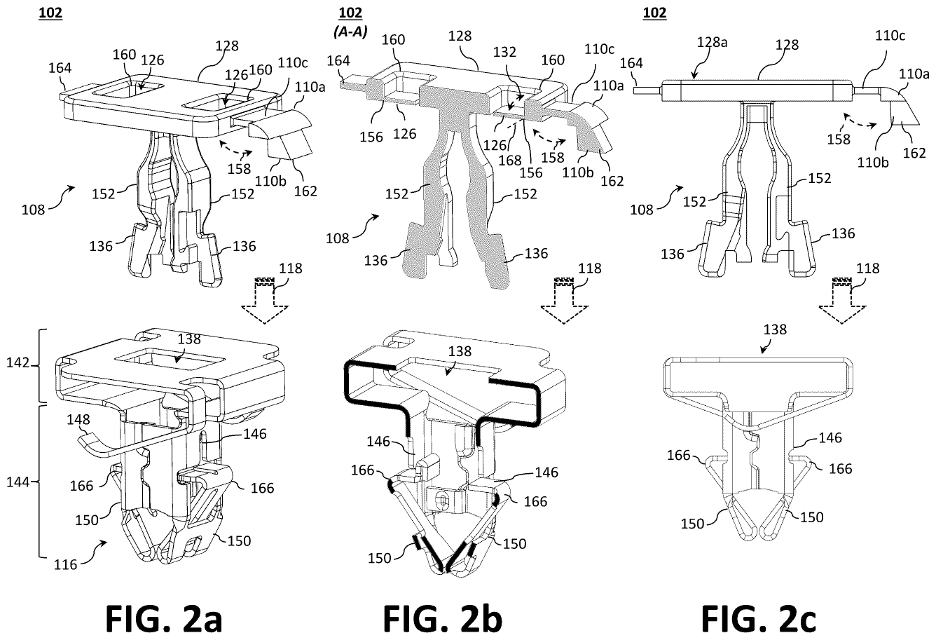

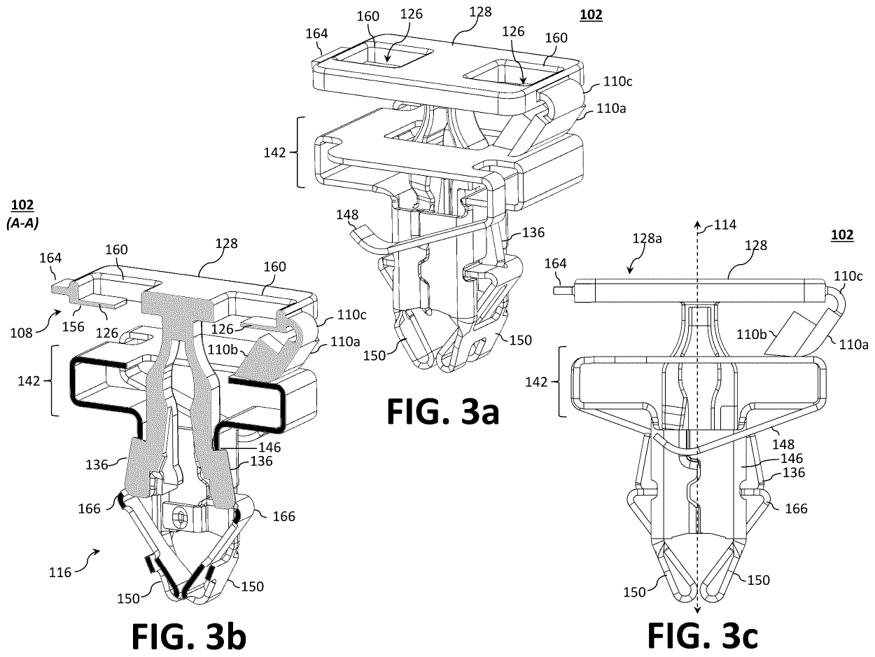

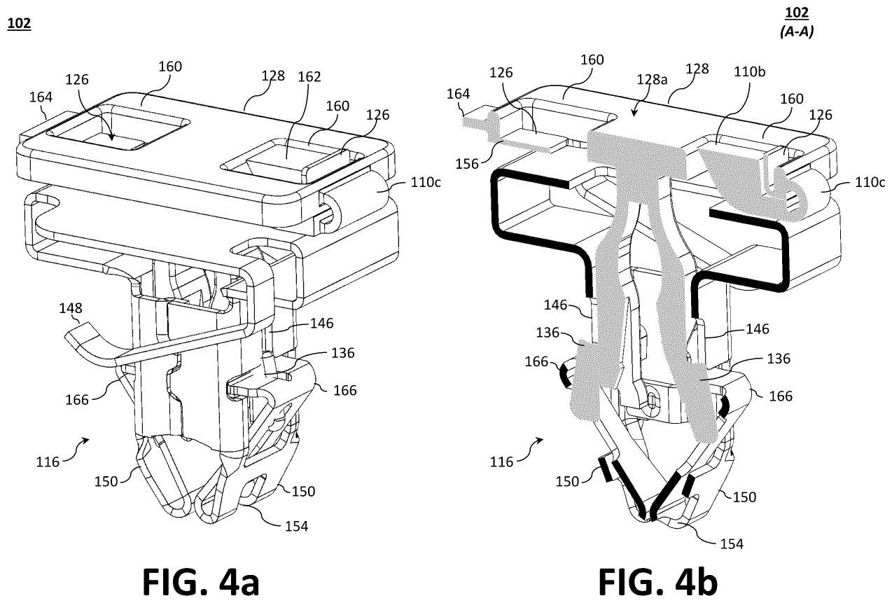

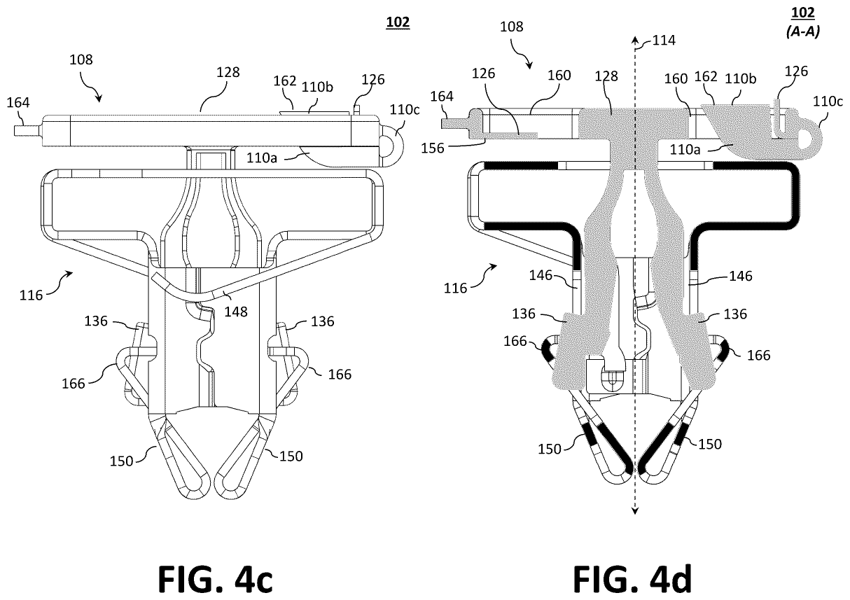

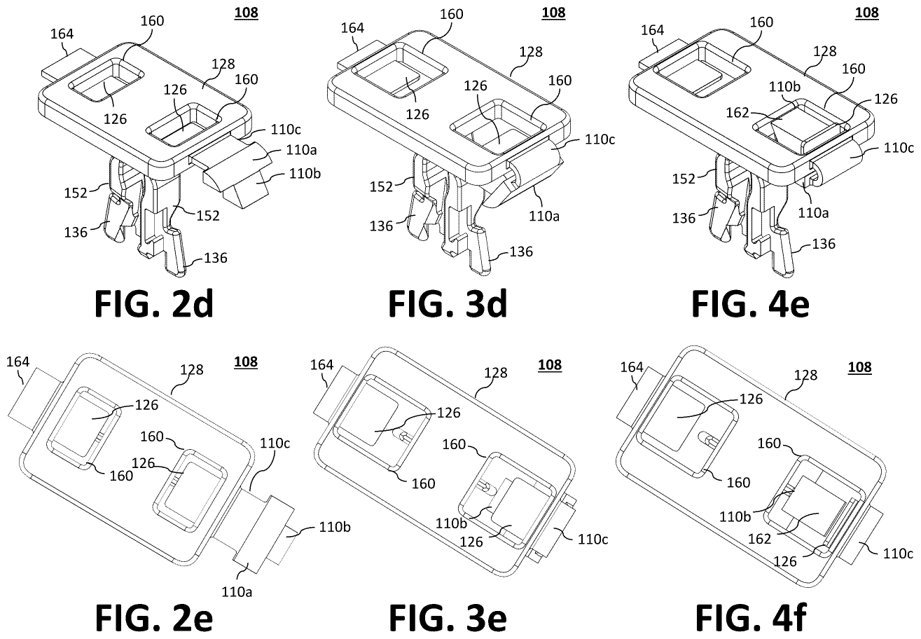

FIGS. 2a through 2e illustrate views of the fastener assembly 102 in a disassembled position. FIGS. 3a through 3e illustrate views of the fastener assembly 102 in a first assembled position (e.g., a shipment position-a part-in-assembly (PIA) position). FIGS. 4a through 4f illustrate views of the fastener assembly 102 in a second assembled position (e.g., a fully assembled position).

As illustrated in the various views, the fastener assembly 102 comprises multiple components, including an assembly-verification insert 108 and a retainer 116, which are configured to engage one another in one or more positions, including the first assembled position (FIGS. 3a through 3e) and the second assembled position (FIGS. 4a through 4f). In some examples, a load plate (not shown) may be disposed between the fastener assembly 102 and the first component 104 to distribute forces from the fastener assembly 102 over a broader area of the first component 104, thereby mitigating potential damage to the components.

More specifically, FIG. 2a illustrates a perspective front view of the fastener assembly 102 in the disassembled position. FIG. 2b illustrates a perspective cross-sectional view of the fastener assembly 102 in the disassembled position, taken along cutline A-A of FIG. 1b. FIG. 2c illustrates a side elevation view of the fastener assembly 102 in the disassembled position. FIG. 2d illustrates a perspective view of the assembly-verification insert 108 of the fastener assembly 102 in the disassembled position. FIG. 2e illustrates a top plan view of the assembly-verification insert 108 of the fastener assembly 102 in the disassembled position.

Similarly, FIG. 3a illustrates a perspective front view of the fastener assembly 102 in the first assembled position (e.g., the shipment position). FIG. 3b illustrates a perspective cross-sectional view of the fastener assembly 102 in the first assembled position, taken along cutline A-A of FIG. 1b. FIG. 3c illustrates a side elevation view of the fastener assembly 102 in the first assembled position. FIG. 3d illustrates a perspective view of the assembly-verification insert 108 of the fastener assembly 102 in the first assembled position. FIG. 3e illustrates a top plan view of the assembly-verification insert 108 of the fastener assembly 102 in the first assembled position.

Finally, FIG. 4a illustrates a perspective front view of the fastener assembly 102 in the second assembled position (e.g., a fully assembled position, in which the assembly-verification insert 108 is fully and properly seated within the retainer 116). FIG. 4b illustrates a perspective cross-sectional view of the fastener assembly 102 in the second assembled position, taken along cutline A-A of FIG. 1b. FIG. 4c illustrates a side elevation view of the fastener assembly 102 in the second assembled position. FIG. 4d illustrates a side elevation cross-sectional view of the fastener assembly 102 in the second assembled position. FIG. 4e illustrates a perspective view of the assembly-verification insert 108 of the fastener assembly 102 in the second assembled position. FIG. 4f illustrates a top plan view of the assembly-verification insert 108 of the fastener assembly 102 in the second assembled position.

The assembly-verification insert 108 includes a verification head assembly 134 and a pair of spring legs 152 extending from the verification head assembly 134. The verification head assembly 134 includes one or more openings 160, one or more blocking tabs 126, and one or more movable plungers 110. Each movable plunger 110 carries or supports at least one installation indicator 162. The blocking tabs 126 and movable plungers 110 are supported by the verification head assembly 134 such that relative movement between the blocking tabs 126 and the movable plungers 110 selectively obstructs or exposes the installation indicators 162. At least one of the openings 160 includes a blocking tab 126 positioned therein. In some examples, each blocking tab 126 is hingedly coupled within the opening 160 via a hinge, such as a living hinge, and is configured to pivot between an obstructing position and a non-obstructing position.

Each of the one or more movable plungers 110 comprises a base portion 110a and a protruding portion 110b. The protruding portion 110b is shaped to extend into or through a corresponding opening 160 of the verification head assembly 134 and to engage the blocking tab 126. Engagement between the protruding portion 110b and the blocking tab 126 causes the blocking tab 126 to pivot, flex, or otherwise move between the obstructing position and the non-obstructing position. The movable plungers 110 are coupled to the verification head assembly 134 via respective hinges 110c, such as living hinges, such that each movable plunger 110 is movable relative to the verification head assembly 134 between a recessed position and an extended position.

The spring legs 152 extend generally perpendicular to the verification head assembly 134 (e.g., the top surface 128a) and are resiliently connected thereto. Each spring leg 152 includes at least one lock tab 136 configured to selectively engage corresponding features of the retainer 116 to secure the assembly-verification insert 108 in one of a plurality of assembled positions relative to the retainer 116. In the illustrated example, each spring leg 152 includes an outwardly oriented lock tab 136 directed away from a central longitudinal axis 114 of the fastener assembly 102.

The retainer 116 includes a body portion 142 and a perpendicular fastener portion 144. The body portion 142 defines a retainer opening 138, through which the spring legs 152 pass during assembly. The fastener portion 144 includes two retainer legs 150 that are resiliently attached beneath the body portion 142. These retainer legs 150 can flex relative to the central longitudinal axis 114 as the fastener portion 144 is inserted through aligned openings 106 and 140 in the first and second components 104 and 112. In some examples, the body portion 142 can include one or more spring tabs 148 configured to contact the first component 104 when installed, thereby mitigating unwanted movement and/or buzz, squeak, and rattle (BSR).

In some examples, each retainer leg 150 comprises an outer portion and an inner portion connected by a bend section. Each of the outer portion and the inner portion can be generally flat, parallel, and spaced apart to form a gap. Each retainer leg 150 may also include one or more guides bent at approximately 90 degrees to span the gap between the outer and inner portions.

Each of the pair of retainer legs 150 defines one or more cutouts configured to selectively receive the lock tabs 136 of the spring legs 152. In the illustrated example, each retainer leg 150 defines a first cutout 146 configured to receive the lock tab 136 when the assembly-verification insert 108 is in a first assembled position (e.g., a PIA position), and a second cutout 154 configured to receive the lock tab 136 when the assembly-verification insert 108 is in a second assembled position. Engagement of the lock tabs 136 with the respective cutouts 146, 154 positively retains the assembly-verification insert 108 in the corresponding assembled position relative to the retainer 116. The retainer 116 may be fabricated as a single component using a metal stamping process. For example, the retainer 116 can be stamped from a sheet of metal using a die stamping process and then bent to assume the shape of the retainer 116 via one or more bending steps. In the illustrated example, each of the pair of retainer legs 150 defines an outwardly facing clip feature 166 configured to engage the first component 104 and/or the second component 112. The clip feature 166 can be integrally formed with the retainer 116, such as via the metal stamping process.

With reference to FIGS. 3a through 3e, the lock tab 136 on the assembly-verification insert 108 is configured to engage the first cutout 146 formed in the retainer 116, thereby securing the assembly-verification insert 108 in a first, or initial, position (such as a shipping position, e.g., a part-in-assembly (PIA) position) during transport of the fastener assembly 102 to the end user. This locked position maintains the integrity of the assembly-verification insert 108, preventing premature movement or activation prior to final installation.

During installation, as the fastener assembly 102 is inserted into the aligned first opening 106 in the first component 104 and the second opening 140 in the second component 112, as indicated by arrow 118, inner walls of the retainer 116 compress the spring legs 152 of the assembly-verification insert 108. This compression causes the lock tab 136 on the assembly-verification insert 108 to release from the first cutout 146 in the retainer 116, thereby allowing the assembly-verification insert 108 to shift in the direction indicated by arrow 118, facilitating proper engagement and assembly verification.

This permits the assembly-verification insert 108 to be pushed into the second assembled position, which corresponds to the final assembled position. Before the assembly-verification insert 108 is fully installed, the visual quality system 120 cannot read the installation indicator(s) 162 (e.g., an assembly verification code, such as a barcode, QR code, or similar) engraved, adhered, or otherwise positioned on the protruding portion 110b of the movable plungers 110. Once the assembly-verification insert 108 is fully seated, with reference to FIGS. 4a through 4f, the lock tab 136 on the assembly-verification insert 108 is configured to engage the second cutout 154 formed in the retainer 116, thereby securing the assembly-verification insert 108 in the second, or final, position (such as an installed position).

That is, prior to full installation, the blocking tabs 126 obstruct visibility of the installation indicators 162 carried by the movable plungers 110. When the assembly-verification insert 108 is fully seated relative to the retainer 116 in the second assembled position, engagement between portions of the retainer 116 and the movable plungers 110 causes the movable plungers 110 to pivot about their respective hinges 110c. This pivoting motion biases the protruding portions 110b of the movable plungers 110 into contact with the blocking tabs 126, thereby displacing the blocking tabs 126 from the obstructing position to the non-obstructing position and exposing the installation indicators 162.

Once installed, the movable plungers 110 pivot to a final inserted position, allowing the visual quality system 120 to read and validate correct and complete installation. As illustrated, scannable installation indicators 162 of the protruding portions 110b, positioned on one or more movable plungers 110 and a fixed body portion 128, become readable only when the movable plungers 110 are biased upward to displace the blocking tabs 126 out of the way. This configuration ensures that the installation indicators 162 of the movable plungers 110 are accessible for scanning only after correct installation, confirming that the retainer legs 150 are properly engaged and that the fastener assembly 102 is securely installed. That is, in the second assembled position, the movable plungers 110 assume an orientation in which the installation indicators 162 are visible and readable. In contrast, when the assembly-verification insert 108 is in the disassembled position or the first assembled position, the movable plungers 110 are recessed or angled relative to the verification head assembly 134 such that the installation indicators 162 are obscured by the blocking tabs 126 or are oriented at an angle that is not readable by the visual quality system 120.

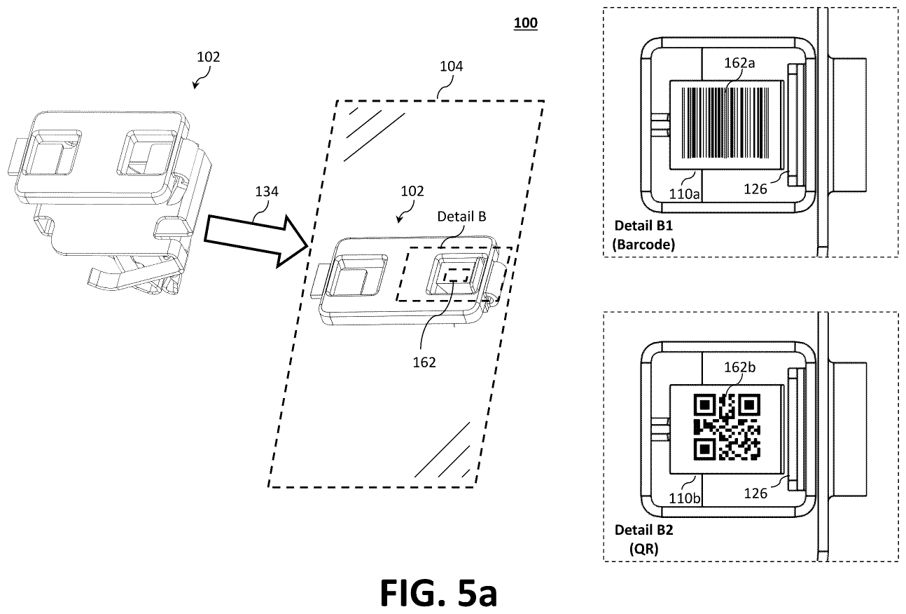

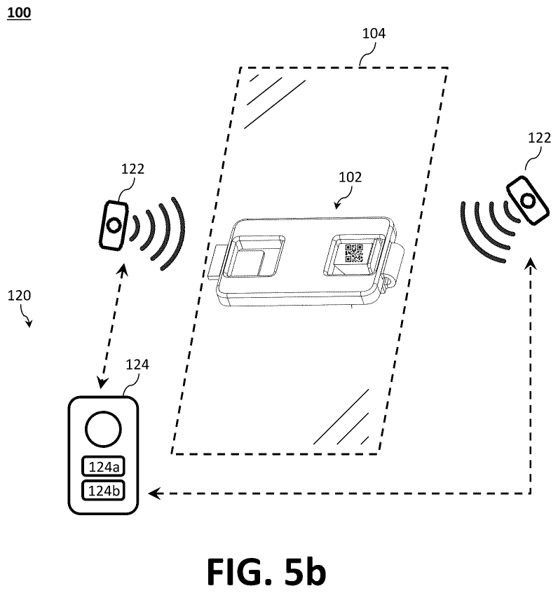

In the illustrated example, to facilitate tracking, the fastener assembly 102 includes an assembly-verification insert 108 having a head assembly 134 coupled to the spring legs 152. The head assembly 134, in an installed position, defines a generally planar surface with openings 160 that support and/or provide for use with one or more installation indicators 162, which can be tracked by a visual quality system 120 (as illustrated and described in FIGS. 5a and 5b) and/or checked manually. When in the fully installed position, the head assembly 134 is a generally flat structure composed of a fixed body portion 128 (fixed relative to the spring legs 152) and one or more movable plungers 110. In the illustrated example, the head assembly 134 comprises a fixed body portion 128 and a movable plunger 110 positioned on a side of the fixed body portion 128. The fixed body portion 128 can further include a grip feature 164 (e.g., a ledge, clip, or similar feature) to enable an operator or robot to better grip the assembly-verification insert 108 during assembly.

The head assembly 134, the blocking tabs 126, and the movable plungers 110 may be integral with the fastener assembly 102. The head assembly 134 includes or provides the blocking tabs 126 and movable plungers 110, which carry the installation indicators 162. The blocking tabs 126 are illustrated as generally planar tabs configured to visibly obstruct the installation indicators 162 when in the disassembled or first assembled position. The installation indicators 162 can be two-dimensional fiducial markers (e.g., a barcode, quick response (QR) code, AprilTag, or similar) positioned on the movable plungers 110 of the head assembly 134. Example barcode 162a and QR code 162b fiducial markers are illustrated in Details B1 and B2 of FIG. 5a. While the head assembly 134 is illustrated as a generally flat structure, other shapes may be used to orient the installation indicators 162 at an appropriate angle relative to the reader 122 when the fastener assembly 102 is properly inserted and seated within the first opening 106 of the first component 104 and the second opening 140 of the second component 112. In another example, the installation indicators 162 can comprise three-dimensional fiducial markers formed on the head assembly 134.

To facilitate movement, the verification head assembly 134 includes one or more hinges 156 and 110c that allow the blocking tabs 126 and the movable plungers 110, respectively, to pivot relative to a fixed body portion 128 of the verification head assembly 134. The movable plungers 110 are configured to pivot between a disassembled position, a first assembled position, and a second assembled position. The second assembled position corresponds to a fully installed condition in which the assembly-verification insert 108 is properly seated within the retainer 116 and the installation indicators 162 are exposed.

When the assembly-verification insert 108 is properly inserted into the retainer 116, interaction between the retainer 116 and the movable plungers 110 causes the movable plungers 110 to pivot into the second assembled position. When the assembly-verification insert 108 is not fully inserted or is improperly seated, the movable plungers 110 remain in the first assembled position or assume a third, intermediate position in which the installation indicators 162 remain obstructed or unreadable.

In the first assembled position of the movable plungers 110, the movable plungers 110 are recessed and arranged at an angle such that the installation indicators 162 are not readable by the visual quality system 120. Once the head assembly 134 has assumed its final, fully seated mounting position after the push-in process in the direction indicated by arrow 118, with the movable plungers 110 having pivoted as indicated by arrows 158 relative to the fixed body portion 128 due to contact with portions of the retainer 116, the fixed body portion 128 and the movable plungers 110 lie in a single plane or in parallel planes. As the blocking tabs 126 have been displaced out of the way, the installation indicators 162 can then be read by the visual quality system 120.

One or more components of the fastener assembly 102 may be formed as a unitary structure. For example, the assembly-verification insert 108 can be fabricated using mold tooling and a plastic injection molding process. In another example, the assembly-verification insert 108 can be a printed thermoplastic component fabricated with high accuracy and fine detail, which is particularly advantageous for creating components requiring complex and/or precise features. Additive manufacturing techniques obviate the need for mold tooling typically associated with plastic injection molding, thereby lowering upfront manufacturing costs, which is particularly advantageous in low-volume production. In some examples, the fastener assembly 102 may be fabricated using material extrusion (e.g., fused deposition modeling (FDM)), stereolithography (SLA), selective laser sintering (SLS), material jetting, binder jetting, powder bed fusion, directed energy deposition, VAT photopolymerization, and/or any other suitable additive manufacturing or three-dimensional (3D) printing process.

Additive manufacturing techniques print objects in three dimensions. Accordingly, both the minimum feature size (i.e., resolution) in the X-Y plane (horizontal resolution) and the layer height along the Z-axis (vertical resolution) are considered in overall printer resolution. Horizontal resolution is the smallest movement the printer's extruder can make within a layer along the X and Y axes, while vertical resolution is the minimum thickness of a layer produced in a single pass. Printer resolution may be expressed in dots per inch (DPI) or micrometers (μm). The particles (3D dots) associated with horizontal resolution may be approximately 50 to 100 μm (approximately 510 to 250 DPI) in diameter.

Typical layer thickness (vertical resolution) is approximately 100 μm (about 250 DPI), although layers may be as thin as 16 μm (approximately 1,600 DPI). The smaller the particles, the higher the horizontal resolution and the greater the detail that the printer can produce. Similarly, the smaller the layer thickness along the Z-axis, the higher the vertical resolution and the smoother the printed surface. Printing at higher vertical resolution, however, typically requires longer build times because the printer must generate a greater number of layers. In some examples, the fastener assembly 102 may be fabricated at different resolutions during a printing operation.

FIGS. 5a and 5b illustrate, respectively, assembly and assembled isometric views of the fastener assembly 102 in combination with the first component 104 (with the second component 112 not shown) and a verification system. For illustrative purposes, the retainer 116 is omitted from the fully assembled views of FIGS. 5a and 5b. As illustrated, the fastening system 100 can be used with a visual quality system 120 having a reader 122 and a computer 124. The visual quality system 120, or a component thereof, can be positioned adjacent to the fastener assembly 102 and/or the first component 104 to monitor assembly of the fastener assembly 102 with the first component 104 and/or the second component 112. In the illustrated example, the visual quality system 120 includes, inter alia, a reader 122 communicatively coupled to a computer 124. The reader 122 can be communicatively coupled to the computer 124 via a wired or wireless link. The reader 122 is arranged to image and/or otherwise track the blocking tab 126 associated with the fastener assembly 102.

In some examples, the head assembly 134 is configured such that one or more installation indicators 162 are not visible to the visual quality system 120 until the assembly-verification insert 108 is fully inserted or assembled. That is, the installation indicators 162 become scannable and visible when the assembly-verification insert 108 is properly seated in the retainer 116 and/or when the fastener assembly 102 is properly seated within the first opening 106 of the first component 104. For example, if the assembly-verification insert 108 is not fully inserted, the movable plungers 110 will not pivot to a fully seated position to bias or displace the one or more blocking tabs 126. In such a condition, the visual quality system 120 may either fail to detect the blocking tabs 126 or determine that an orientation or angle of the installation indicators 162, or of the one or more blocking tabs 126, is incorrect. In either case, the visual quality system 120 may indicate an error or anomaly.

If the computer 124, via one or more processors 124a coupled to a memory device 124b, determines—based at least in part on the one or more blocking tabs 126—that the fastener assembly 102 is not properly mounted to the first component 104, an alert may be communicated to an operator (e.g., via a portable communication device). Additionally or alternatively, when robotic assembly is employed, a robot may automatically repeat the assembly process to correct the error.

While a single movable plunger 110 and a single installation indicator 162 are illustrated, the assembly-verification insert 108 may include a plurality of movable plungers 110, each carrying a corresponding installation indicator 162. The movable plungers 110 may be positioned symmetrically or asymmetrically about the verification head assembly 134 to provide redundancy and to increase verification accuracy by supplying multiple independent positional data points. For example, a second movable plunger 110 may be positioned opposite the illustrated movable plunger 110 to interface with another opening 160, in addition to or in lieu of the illustrated grip feature 164.

Each movable plunger 110 and each blocking tab 126 may be coupled to the head assembly 134 via a living hinge, such as hinges 156 and 110c. The installation indicator 162 may be printed directly on the movable plunger 110, applied as a sticker, or otherwise affixed thereto. The movable plungers 110 are coupled to the fixed body portion 128 of the head assembly 134 via hinges 110c. The movable plungers 110 are configured to pivot between a disassembled position, a first assembled position, and a second assembled position. Specifically, the head assembly 134 and movable plungers 110 assume the second assembled position when the assembly-verification insert 108 is properly seated within the retainer 116 of the body portion 142. The reader 122, which is separate from the fastener assembly 102 and operatively coupled to the computer 124, is configured, via the processor 124a, to track the installation indicator 162 during installation of the fastener assembly 102.

While the present method and/or system has been described with reference to certain implementations, those skilled in the art will understand that various changes may be made and equivalents may be substituted without departing from the scope of the present method and/or system. In addition, numerous modifications may be made to adapt a particular situation or material to the teachings of the present disclosure without departing from its scope. For example, blocks and/or components of the disclosed examples may be combined, divided, rearranged, and/or otherwise modified. Accordingly, the present method and/or system is not limited to the particular implementations disclosed, but instead includes all implementations falling within the scope of the appended claims, both literally and under the doctrine of equivalents.

1. An assembly-verification insert for use with a fastener assembly, the assembly-verification insert comprising:
a verification head;
a pair of spring legs extending from the verification head;
at least one blocking tab coupled to the verification head; and
at least one movable plunger coupled to the verification head,
wherein the at least one movable plunger comprises an installation indicator, and
wherein the at least one movable plunger is movable relative to the verification head between a first position in which the blocking tab obstructs the installation indicator and a second position in which the installation indicator is visible.

2. The assembly-verification insert of claim 1, wherein the verification head comprises a fixed body portion and the at least one movable plunger is coupled to the fixed body portion via a hinge.

3. The assembly-verification insert of claim 2, wherein the hinge is a living hinge.

4. The assembly-verification insert of claim 1, wherein the blocking tab is hingedly coupled to the verification head and configured to pivot between an obstructing position and a non-obstructing position.

5. The assembly-verification insert of claim 4, wherein movement of the movable plunger biases the blocking tab from the obstructing position to the non-obstructing position.

6. The assembly-verification insert of claim 1, wherein the installation indicator is positioned on a protruding portion of the movable plunger.

7. The assembly-verification insert of claim 1, wherein the installation indicator comprises a fiducial marker.

8. The assembly-verification insert of claim 7, wherein the fiducial marker comprises a barcode, a quick response (QR) code, an AprilTag, or a combination thereof.

9. The assembly-verification insert of claim 1, wherein each of the pair of spring legs comprises a lock tab configured to engage a retainer.

10. The assembly-verification insert of claim 9, wherein the lock tab is configured to secure the assembly-verification insert in a first assembled position and a second assembled position relative to the retainer.

11. The assembly-verification insert of claim 1, wherein the assembly-verification insert is formed as a unitary plastic component.

12. The assembly-verification insert of claim 1, wherein the movable plunger is movable between a pre-installation position and an installed position.

13. A fastener assembly for coupling a first component relative to a second component, the fastener assembly comprising:
an assembly-verification insert comprising
a verification head,
a pair of spring legs extending from the verification head,
at least one blocking tab supported by the verification head, and
at least one movable plunger coupled to the verification head and comprising an installation indicator; and
a retainer having a body portion defining a retainer opening and a pair of retainer legs resiliently coupled to the body portion,
wherein the retainer opening is configured to receive the pair of spring legs, and
wherein engagement between the retainer and the movable plunger causes the movable plunger to move such that the installation indicator becomes visible.

14. The fastener assembly of claim 13, wherein each of the pair of spring legs comprises a lock tab.

15. The fastener assembly of claim 14, wherein each of the pair of retainer legs defines a first cutout configured to receive the lock tab to secure the assembly-verification insert in a first assembled position.

16. The fastener assembly of claim 15, wherein each of the pair of retainer legs further defines a second cutout configured to receive the lock tab to secure the assembly-verification insert in a second assembled position.

17. The fastener assembly of claim 16, wherein the first assembled position is a part-in-assembly (PIA) position and the second assembled position is a fully installed position.

18. The fastener assembly of claim 13, wherein the verification head comprises a fixed body portion and the at least one movable plunger is coupled to the fixed body portion via a hinge.

19. The fastener assembly of claim 18, wherein the movable plunger is configured to pivot relative to the fixed body portion between a recessed position and an installed position.

20. The fastener assembly of claim 13, wherein the blocking tab is configured to prevent detection of the installation indicator prior to full installation of the fastener assembly.
